(19) United States
(12) Patent Application Publication
(10) Pub. No.: US 2005/0097708 A1
(43) Pub. Date: May 12, 2005

(54) Shock-absorbing handle for impact tool

(76) Inventor: Bruce Allan Crawford, Cookeville, TN (US)

Correspondence Address: James Addison Barry, Jr., 105 Glenway Point, Lebanon, TN, 37087, US

(21) Appl. No.: 10/980,059

(22) Filed: Nov. 3, 2004

Related U.S. Application Data
(60) Provisional application No. 60/519,036, filed on Nov. 8, 2003.

(51) Int. Cl. B25D 1/00

(52) U.S. Cl. 16/431

(57) ABSTRACT

The present invention is a shock-absorbing apparatus that dampens the impact between a hand and an impact tool 120. The apparatus includes a handle 110 that can be gripped in the hand and allow the impact tool 120 movement within the handle 110. A shock-absorbing means 130 provides a shock-absorbing function to the handle 110. A stopping means 132 limits the movement of one end of the impact tool 120. The handle 110 may include a flange extending from the upper region of the handle 110 to provide protection from hand injury, and a gripping surface on the exterior of the handle 110 that cushions and enhances the grip and control of the impact tool 120.

### CROSS-REFERENCE TO RELATED APPLICATIONS

This application claims the benefit of U.S. Provisional Application No. 60/519,036, filed with the U.S. Patent and Trademark Office on Nov. 8, 2003, and titled “Shock-Absorbing Handle for Impact Tool.”

### FIELD OF THE INVENTION

The present invention relates to a hand tool that dampens the impact between a hand and an impact tool.

### BACKGROUND OF THE INVENTION

Many tools exist that are designed to convert the impact of a hammer blow on one part of the tool into useable kinetic energy at the working or cutting end of the tool. These tools include all types of chisels, punches, drifts, impact drills, etc. and can, for example, be used to break bricks, chip concrete, cut through steel bars, create punch marks, drill holes and so forth by displacing material upon impact.

Several potential problems and dangers exist for users of these types of tools. First, the user must grip the tool firmly in his hand in such a way as to guide the tool during the interim between hammer blows and keep the working or cutting end of the tool in position. Because of the grip required, much of the kinetic energy from the hammer blow is transferred to the hand, fingers, wrist and arm. The user subjected to this type of rapid energy dissipation from the tool into the body for long periods of time may suffer a whole host of injuries related to impact and repetitive motion. Second, the surface upon which the hammer blows must fall for most of these types of tools is small in area. In order to keep from hitting his hand and causing injury, the user must take care to constantly shift his focus between the working or cutting end of the tool and the end of the tool upon which his hammer blows are falling.

Therefore it would be desirable to have an impact tool that: temporarily stores the energy transferred to the tool by the impact of a hammer and then transfers the energy back to the tool instead of transferring the energy to the fingers, hand, wrist and arm, thus providing an aid in protecting the user from the potential injurious effects of shock and repetitive motion; helps protect the user's hand from injury in the event that a hammer blow either misses or glances off the intended point of impact on the proximal end of the tool by including a flange or expanded region above the grip portion of the handle; provides the user with a comfortable ergonomically designed gripping surface; is easy and economical to manufacture and assemble; and can either be designed and manufactured as a stand-alone aftermarket device that is attached with a conventional impact tool or integrated into the manufacturing process of the impact tool itself.

### SUMMARY OF THE INVENTION

The present invention provides an impact tool that: temporarily stores the energy transferred to the tool by the impact of a hammer and then transfers the energy back to the tool instead of transferring the energy to the fingers, hand, wrist and arm, thus providing an aid in protecting the user from the potential injurious effects of shock and repetitive motion; helps protect the user's hand from injury in the event that a hammer blow either misses or glances off the intended point of impact on the proximal end of the tool a flange or expanded region above the grip portion of the handle; provides the user with a comfortable ergonomically designed gripping surface; is easy and economical to manufacture and assemble; and can either be designed and manufactured as a stand-alone aftermarket device that is attached with a conventional impact tool or integrated into the manufacturing process of the impact tool itself.

One embodiment of the present invention provides a shock-absorbing apparatus, which dampens the impact between a hand and an impact tool, with the shock-absorbing apparatus comprising a handle comprising a formed component that can be gripped in the hand and allow the impact tool movement within the handle; a shock-absorbing means disposed along an axis of the impact tool to provide a shock-absorbing function to the handle; and a stopping means disposed along an axis of the impact tool to limit the movement of the impact tool in relation to the handle.

In another embodiment of the present invention, the handle includes a flange extending from the upper region of the handle to provide protection from hand injury. In yet another embodiment of the present invention, the handle further includes a gripping surface on the exterior of the handle that cushions and enhances the grip and control of the impact tool. In another embodiment of the present invention, the formed component of the handle comprises the shock-absorbing means so as to allow the handle to provide the shock-absorbing function. In yet another embodiment of the present invention, the shock-absorbing means comprises a spring disposed along the axis of the impact tool to provide the shock-absorbing function to the handle. In still another embodiment of the present invention, the shock-absorbing means comprises a resilient material disposed along the axis of the impact tool to provide the shock-absorbing function to the handle. In yet another embodiment of the present invention, the shock-absorbing means comprises friction along the axis of the impact tool to limit the movement of the impact tool. In another embodiment of the present invention, the stopping means comprises a collar as part of the impact tool to limit the movement of the shock-absorbing means. In yet another embodiment of the present invention, the stopping means is incorporated into the design of the impact tool to limit the movement of the impact tool. In still another embodiment of the present invention, the stopping means comprises an aggregate on the proximal end of the impact tool to limit the movement of the impact tool. In another embodiment of the present invention, the stopping means comprises a resilient material disposed along the axis of the impact tool to limit the movement of the impact tool.

In another embodiment of the present invention, the handle further comprises a flange extending from the upper region of the handle to provide protection from hand injury, and a gripping surface on the exterior of the handle that cushions and enhances the grip and control of the impact tool; the shock-absorbing means comprises a spring; and wherein the stopping means comprises a collar disposed along the axis of the impact tool to limit the movement of the impact tool. In yet another embodiment of the present invention, the handle further comprises a flange extending from the upper region of the handle to provide protection from hand injury, and a gripping surface on the exterior of the handle that cushions and enhances the grip and control of the impact tool; and the shock-absorbing means and the stopping means comprise a resilient material disposed along the axis of the impact tool to provide a shock-absorbing function to the handle and to limit the movement of the impact tool.

### BRIEF DESCRIPTION OF THE DRAWINGS

These and other features, aspects, and advantages of the invention will become better understood with regard to the following description, appended claims, and accompanying drawings where:

FIG. 1 is a perspective view depicting the components according to the present invention;

FIG. 2 is a perspective view depicting a recessed area of the handle according to the present invention;

FIG. 3 is a perspective view illustrating components according to the present invention;

FIG. 4 is a perspective view of the present invention in use before hammer impact; and

FIG. 5 is a perspective view of the present invention in use after hammer impact.

### DETAILED DESCRIPTION OF THE INVENTION

The present invention relates to the field of impact tools. More specifically, this disclosure presents a shock-absorbing handle for impact tools. The following description is presented to enable one of ordinary skill in the art to make and use the invention and to incorporate it in the context of particular applications. Various modifications, as well as a variety of uses in different applications will be readily apparent to those skilled in the art, and the general principles defined herein may be applied to a wide range of embodiments. Thus, the present invention is not intended to be limited to the embodiments presented, but is to be accorded the widest scope consistent with the principles and novel features disclosed herein.

Overview of the Invention:

The present invention is a shock-absorbing handle. The shock-absorbing handle may be attached with or be incorporated into the design of typical chisels, punches, masonry drills and other such tools that are designed to convert the impact of hammer blows on one end of the tool into useable kinetic energy at the working or cutting end of the tool. In addition to reducing the shock experienced by the hand, fingers, wrist and arm while using such tools, this invention is also designed to aid in protecting the fingers and hand from injury resulting from misplaced hammer blows as well as provide a firm, yet comfortable ergonomic grip for the user's hand.

Design Specifications:

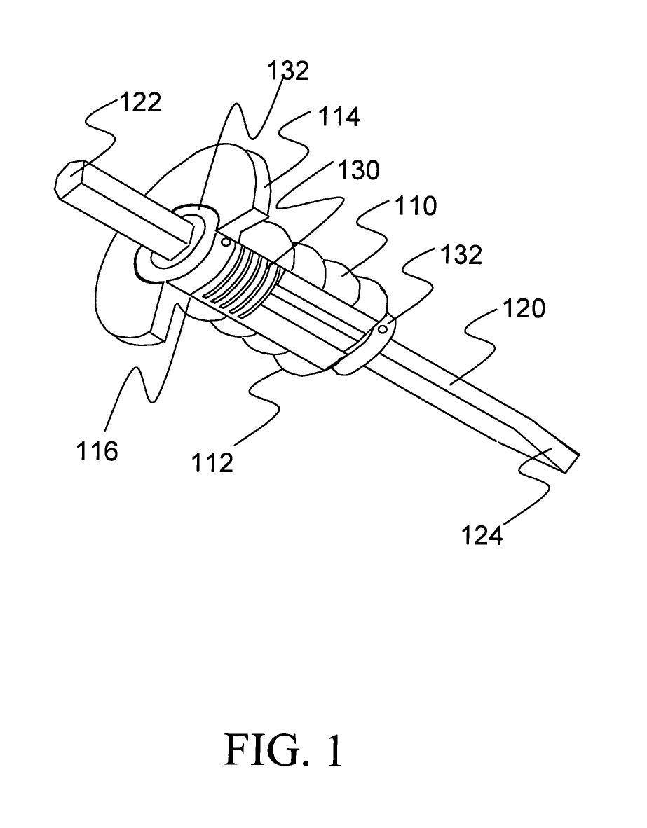

The invention consists of a handle 110 that can be attached with or incorporated into the design of an impact tool 120 such as that shown representatively in FIG. 1.

Impact Tool:

An impact tool 120, as defined herein, is any implement, which is designed to transfer the kinetic energy imparted by an impact or blow at a proximal end 122 along its longitudinal axis to the opposite distal end 124. The impact tool 120 may include but is not limited to chisels, punches, and masonry drills. The impact tool 120 may also include interchangeable tips wherein the tips may be detached and interchanged for the particular job at hand. Various methods may be used to hold the tips in place including those with a locking mechanism to lock the tip in place so it will not come out.

Handle:

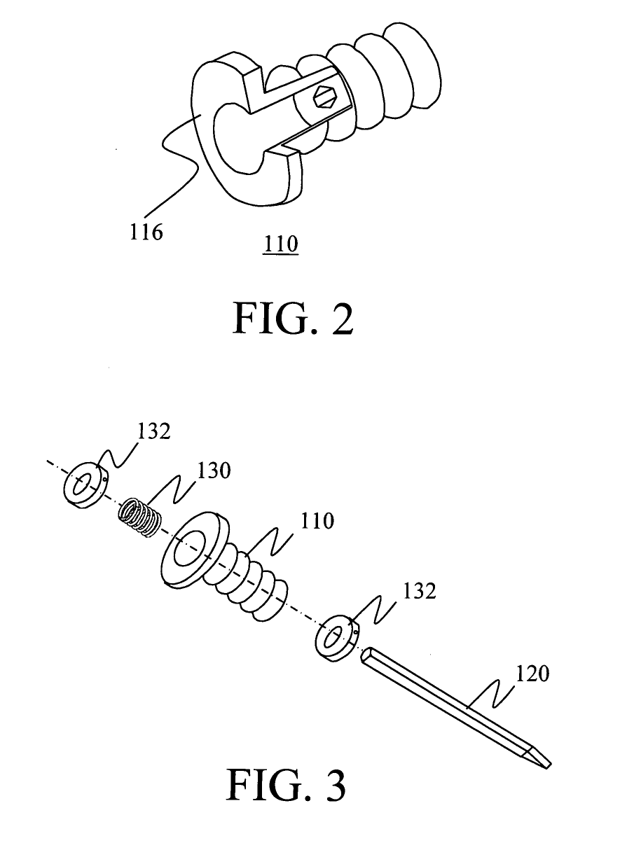

A handle 110, as defined herein, is a mechanically formed component of any shape or material or combination thereof, which can be gripped in the hand and/or fingers and allow the impact tool 120 movement within the handle while being gripped. The handle 110 may be fashioned from any variety of materials or combinations thereof and/or may be formed or molded into any shape consistent with the intended use of the impact tool 120. In one embodiment the formed component of the handle 110 may comprise the shock-absorbing means 130 wherein the formed component may be comprised of a resilient material with a memory such that the material returns to the original position after displacement from the original position. In another embodiment the handle 110 may be made in one or more pieces depending upon the method of manufacturing and assembly selected. When the handle 110 is made in more than one piece, the handle 110 may include a locking mechanism to secure the pieces together around the impact tool 120. In yet another embodiment the handle 110 may be molded directly on the impact tool 120. In some embodiments the handle 110 comprises a slot along the axis of the handle 110 for the impact tool 120 to be free to move within the handle 110. The slot for the impact tool 120, or a portion thereof, may be hexagon, oval, rectangle, square, or other shape that may match the impact tool 120 shape. The handle 110 may be shaped or manufactured in such a way as to provide the user with a gripping surface 112 for grasping the impact tool 120. The design of the gripping surface 112 may take any variety of forms. This gripping surface 112 may be either separate from or homogeneous with the material comprising the handle 110. The handle 110 may also consist of one or more materials that are compliant and serve to cushion the user's grip. The gripping surface 112 may comprise a sponge type material for a sure-soft grip molded over the handle 110. The handle 110 may comprise a flange 114 extending from the upper region of the handle in order aid in providing protection from injury due to misplaced blows otherwise intended to strike the proximal end of the impact tool 120. The handle 110 may contain one or more recessed areas 116 at either axial end or within the interior of the handle 110 for the purpose of either partially or fully containing one or more shock-absorbing means 130 and/or the impact tool 120. FIG. 2 depicts one of many locations that could be used for the recessed area 116 in the handle 110.

Shock-Absorbing Means:

One embodiment of the shock-absorbing means 130 is illustrated in FIG. 3. The shock-absorbing means 130, as defined herein, may include, but is not limited to the use of one or more or a combination of the following:
(a) Shaped metallic or non-metallic springs and/or spring washers;
(b) Compressible, extensible or otherwise pliant regions and/or components that are capable of being compressed or extended under load and thereafter return to their original shape, volume and dimensions upon elimination of the load including contained compressible fluids and/or gases;
(c) Various designs, such as a handle with pliant flexible ribs, that allow the handle material to flex and then return to the original position; or
(d) Resilient material with a memory such that the material returns to the original position after displacement from the original position.

The compressible, extensible or pliant regions may be manufactured as either separate components and/or assemblies or be incorporated into the design of the handle 110 or the impact tool 120. The shock-absorbing means 130 may be designed and positioned in any manner that is required to provide a shock-absorbing function to the handle 110 of the impact tool 120 including, but not limited to being located either partially or fully within any recesses present at either end of the handle 110; between the handle 110 and the impact tool 120; or partially or fully within the handle 110 itself. In the absence of recesses at either or both ends of the handle 110, the shock-absorbing means 130 may alternatively be located outside the handle 110, or at either or both ends of the handle 110 and extend outwardly and axially therefrom. In one embodiment one the end of the shock-absorbing means 130 may be either affixed with the impact tool 120 or may be otherwise limited in its movement along the axis of the impact tool 120 by the use of one or more stopping means 132. The opposing end of the shock-absorbing means 130 may bear against the handle 110 at some point, but does not necessarily need to touch it or be attached with it. In the event that a contained compressible fluid and/or gas is utilized as the shock-absorbing means 130, one end of the vessel that contains such compressible fluid and/or gas may either be affixed with the impact tool 120 or otherwise may be limited in its movement as described above. The opposing end of the vessel that contains such compressible fluid and/or gas may bear against the handle 110 at some point, but does not necessarily need to touch it or be attached with it. A representative location for the shock-absorbing means 130 is shown in FIG. 1. The shock-absorbing means 130 may comprise friction along the axis of the impact tool 120 to provide the shock-absorbing function to the handle 110. The shock-absorbing means 130 may comprise a resilient material disposed along the axis of the impact tool 120 to provide the shock-absorbing function to the handle 110. The resilient material may bond to the handle 110 or the formed component of the handle 110 may comprise the resilient material. The resilient material may also bond the handle 110 to the impact tool 120. The resilient material provides some movement between the handle 110 or hand, and the impact tool 120 but allows only limited movement. After impact, the impact tool 120 returns to its steady state position within the handle 110. In another embodiment the shock-absorbing means 130 may comprise pliant flexible ribs designed into the handle 110. This would allow the handle 110 to give so as to dampen shock from impact and then return to its steady state position. The pliant flexible rib handle and the resilient material handle mentioned are two of several means where the handle 110 and the shock-absorbing means 130 may be incorporated into one member.

Stopping Means:

Whether one or more, as depicted in FIG. 1, the stopping means 132 is defined herein as the use of any mechanical means or manufacturing method utilized to limit the movement of the impact tool 120 within either the handle 110 or within one or both ends of the shock-absorbing means 130. This stopping means 132 may be a separate mechanical component, for example a collar, or the stopping means 132 may be incorporated into the design of the shock-absorbing means 130, the impact tool 120, or the handle 110 depending upon the manufacturing method selected. A representative location for the stopping means 132 is shown in FIG. 1 and FIG. 3. In one embodiment the stopping means 132 may comprise as part of the design of the impact tool 120 an aggregate or mass of material on the proximal end of the impact tool 120 to limit the movement of the impact tool 120. The stopping means 132 may be a bonding such as a resilient material between the handle 110 and the impact tool 120 limiting the movement of the impact tool 120. Grooves, 0-rings, or etchings may also be useful as stopping means 132. The stopping means 132 may be bonded to the impact tool 120 by numerous mechanical means such as but not limited to the following: set screws; dissimilar heating of the stopping means 132 and the impact tool 120 then pressing a stopping means 132 over the impact tool 120 and allowing to cool; or weld or chemical bonding of the stopping means 132 and the impact tool 120.

Manner of Use:

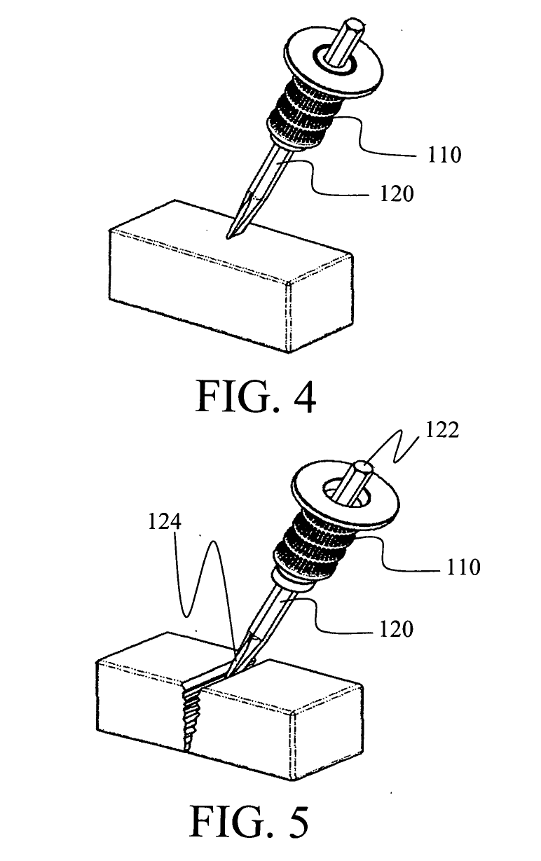

As representatively shown in FIG. 4, the user first places the distal end 124, the working or cutting edge, of the impact tool 120 against the material to be cut, punched, chipped or otherwise manipulated and then positions the proximal end 122 of the impact tool 120 at an angle convenient to receive blows from a hammer or other means of impact. The user grips the handle 110 portion of the impact tool 120 and impacts the proximal end 122 of the impact tool 120. Upon receiving an impact, the impact tool 120 travels axially towards the material being worked as shown representatively in FIG. 5. In one embodiment as depicted in FIG. 1, the handle 110 is restrained from movement by virtue of being gripped; therefore, as the impact drives the impact tool 120 through the handle 110, the stopping means 132 that affixes one end of the shock-absorbing means 130 to the impact tool 120 moves against the shock-absorbing means 130 and either compresses or extends it depending on the mounting location of the shock-absorbing means 130. In another embodiment where the stopping means is flexible material, the flexible material restrains and limits the travel of the impact tool 120. This compression or extension temporarily stores some of the kinetic energy transferred to the impact tool 120 by the impact. This stored energy from the impact that would otherwise have been felt by the user's fingers, hand, wrist and arm in the form of a shock is then transferred back to the impact tool 120, not the handle 110, as the shock-absorbing means 130 either extends or retracts, causing the impact tool 120 to return to its pre-impact position.

Uniqueness:

As depicted in FIG. 1, the uniqueness of this invention is illustrated in many ways, five of which are as follows. First, the design of the handle 110, including the incorporation of a shock-absorbing means 130 as defined herein, allows the energy transferred to the impact tool 120 by an impact to be temporarily stored and then transferred back to the impact tool 120 instead of the fingers, hand, wrist and arm, thus providing an aid in protecting the user from the potential injurious effects of shock and repetitive motion.

Second, the design of the handle 110 includes a flange 114 or expanded region above the grip portion of the handle 110 between the user's hand and the end of the impact tool to be impacted by a hammer or other means of impact. This flange 114 or expanded region aids in protecting the user's hand from injury in the event that a hammer blow either misses or glances off of the intended point of impact on the proximal end of the impact tool.

Third, the handle 110 can be ergonomically designed to incorporate features that provide the user with a comfortable gripping surface 112 that both cushions and enhances the grip as well as the user's control of the impact tool 120.

Fourth, the simplicity of the design of the invention and the variety of inexpensive materials from which it may be constructed is such that it is easy and economical to manufacture and assemble.

Fifth, the handle 110 can either be designed and manufactured as a stand-alone aftermarket device that is attached with a conventional impact tool or integrated into the manufacturing process of the impact tool itself.

1. A shock-absorbing apparatus for dampening the impact between a hand and an impact tool, the shock-absorbing apparatus comprising:
a. a handle comprising a formed component that can be gripped in the hand and allow the impact tool movement within the handle;
b. a shock-absorbing means disposed along an axis of the impact tool to provide a shock-absorbing function to the handle; and
c. a stopping means disposed along the axis of the impact tool to limit the movement of the impact tool in relation to the handle.

2. A shock-absorbing apparatus as set forth in claim 1, wherein the handle further comprises a flange extending from the upper region of the handle to provide protection from hand injury.

3. A shock-absorbing apparatus as set forth in claim 1, wherein the handle further comprises a gripping surface on the exterior of the handle that cushions and enhances the grip and control of the impact tool.

4. A shock-absorbing apparatus as set forth in claim 1, wherein the formed component of the handle comprises the shock-absorbing means so as to allow the handle to provide the shock-absorbing function.

5. A shock-absorbing apparatus as set forth in claim 1, wherein the shock-absorbing means comprises a spring disposed along the axis of the impact tool to provide the shock-absorbing function to the handle.

6. A shock-absorbing apparatus as set forth in claim 1, wherein the shock-absorbing means comprises a resilient material disposed along the axis of the impact tool to provide the shock-absorbing function to the handle.

7. A shock-absorbing apparatus as set forth in claim 1, wherein the shock-absorbing means comprises friction along the axis of the impact tool to provide the shock-absorbing function to the handle.

8. A shock-absorbing apparatus as set forth in claim 1, wherein the stopping means comprises a collar as part of the impact tool to limit the movement of the impact tool.

9. A shock-absorbing apparatus as set forth in claim 1, wherein the stopping means is incorporated into the design of the impact tool to limit the movement of the impact tool.

10. A shock-absorbing apparatus as set forth in claim 9, wherein the stopping means comprises an aggregate on the proximal end of the impact tool to limit the movement of the impact tool.

11. A shock-absorbing apparatus as set forth in claim 1, wherein the stopping means comprises a resilent material disposed along the axis of the impact tool to limit the movement of the impact tool.

12. A shock-absorbing apparatus as set forth in claim 2, wherein the handle further comprises a gripping surface on the exterior of the handle that cushions and enhances the grip and control of the impact tool; the shock-absorbing means comprises a spring; and wherein the stopping means comprises a collar disposed along the axis of the impact tool to limit the movement of the impact tool.

13. A shock-absorbing apparatus as set forth in claim 2, wherein the handle further comprises a gripping surface on the exterior of the handle that cushions and enhances the grip and control of the impact tool; and the shock-absorbing means and the stopping means comprise a resilent material disposed along the axis of the impact tool to provide a shock-absorbing function to the handle and to limit the movement of the impact tool.
